(19) United States
(12) Patent Application Publication
(10) Pub. No.: US 2023/0094750 A1
(43) Pub. Date: Mar. 30, 2023

(54) CERAMIC MATRIX COMPOSITE COMPONENTS WITH MICROSTRUCTURE FEATURES

(71) Applicant: Rolls-Royce plc, London (GB)

(72) Inventors: Ian M. Edmonds, Derby (GB); Anthony G. Razzell, Derby (GB)

(21) Appl. No.: 17/491,487

(22) Filed: Sep. 30, 2021

(51) Int. Cl. C04B 35/80; F01D 9/04; C04B 35/628

(52) U.S. Cl. CPC C04B 35/80; F01D 9/041; C04B 35/62844; F05D 2220/32; F05D 2240/12; F05D 2230/20; C04B 2235/5252

(57) ABSTRACT

A method of forming a ceramic matrix composite component. The ceramic matrix composite component is adapted for use in a gas turbine engine. The method including forming the component using ceramic materials and infiltrating the component with a matrix material.

### FIELD OF THE DISCLOSURE

The present disclosure relates generally to components for gas turbine engines, and more specifically to components that comprise ceramic-containing materials.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

Products of the combustion reaction directed into the turbine flow over airfoils included in stationary vanes and rotating blades of the turbine. The interaction of combustion products with the airfoils heats the airfoils to temperatures that require the airfoils to be made from high-temperature resistant materials and/or to be actively cooled by supplying relatively cool air to the vanes and blades. To this end, some airfoils for vanes and blades, along with other components in the engine are incorporating composite materials adapted to withstand very high temperatures. Design and manufacture of vanes, blades, and other components from composite materials presents challenges because of the geometry and strength required for the parts.

### SUMMARY

The present disclosure may comprise one or more of the following features and combinations thereof.

A method of forming a ceramic matrix composite component may comprise providing a first set of ceramic tows and providing a second set of ceramic tows. The first set of ceramic tows may each have a first filament composition. The second set of ceramic tows may each have a second filament composition. The second filament composition may be different from the first filament composition by varying at least one of a mean filament size of filaments included each tow, a filament size distribution of each tow, and a number of filaments per each tow.

In some embodiments, the method may further comprise forming a first section of the component using tows from the first set of ceramic tows and forming a second section of the component using tows from the second set of ceramic tows. In some embodiments, the second section of the component may be different from the first section.

In some embodiments, the method may further comprise infiltrating the component with matrix material to produce a first intra-tow porosity in the first section of the component and a second intra-tow porosity in the second section of the component. The second intra-tow porosity of the second section may be different from the first intra-tow porosity of the first section.

In some embodiments, the method may further comprise restricting the matrix material from infiltrating the component at a predetermined surface area of the component.

In some embodiments, the second filament composition may be different from the first filament composition by varying the mean filament size of the filaments included each tow, the filament size distribution of each tow, and the number of filaments per each tow. In some embodiments, the second filament composition may have a mean filament size that is less than a mean filament size of the first filament composition. In some embodiments, the second filament composition may have a mean filament size that is greater than a mean filament size of the first filament composition.

In some embodiments, the ceramic matrix composite component may be a turbine vane adapted for use in a gas turbine engine. The turbine vane may include an outer platform, an inner platform, and an airfoil. The outer platform may extend circumferentially at least partway about a central axis of the gas turbine engine. The inner platform may extend circumferentially at least partway about the central axis of the gas turbine engine. The inner platform may be spaced apart radially from the outer platform. The airfoil may extend radially between the outer and inner platforms.

In some embodiments, the step of forming the first section of the component may include forming an inner tube of the airfoil and the step of forming the second section of the component may include forming an outer shell of the airfoil. The method may further include assembling the inner tube into the outer shell of the airfoil before infiltrating the component.

In some embodiments, the airfoil may be shaped to redirect air flowing through the gas turbine engine by having a leading edge, a trailing edge spaced apart axially from the leading edge, a pressure side, and a suction side spaced apart circumferentially from the pressure side. The pressure side and the suction side may extend between and interconnect the leading edge and the trailing edge.

In some embodiments, the method may further comprise restricting the matrix material from infiltrating the component at a predetermined surface area. The predetermined surface area may be on at least one of the leading edge, the trailing edge, the pressure side, and the suction side of the component.

These and other features of the present disclosure will become more apparent from the following description of the illustrative embodiments.

### BRIEF DESCRIPTION OF THE DRAWINGS

FIG. 1 is a perspective view of a ceramic matrix composite component for use in a gas turbine engine showing the ceramic matrix composite component may be a turbine vane formed to include an airfoil that extends radially relative to an axis of the gas turbine engine that redirects air moving through a primary gas path in the gas turbine engine and two platforms that extend circumferentially partway about the axis to define a inner and outer boundaries of the gas path of the gas turbine engine;

FIG. 2 is a cross-section view of the ceramic matrix composite component of FIG. 1 showing a microstructure of the ceramic matrix composite materials that form the component at different locations on the component;

FIG. 2A is an enlarged detail view of FIG. 1 showing the microstructure of the ceramic matrix composite materials includes smaller filaments and a greater number of filaments per tow to increase the toughness of the ceramic matrix composite materials;

FIG. 2B is an enlarged detail view of FIG. 1 showing the microstructure of the ceramic matrix composite materials includes larger filaments and a fewer number of filaments per tow to increase the proportional limit of the ceramic matrix composite material;

FIG. 3 is an elevation view of a tow used to form the component of FIG. 1 showing the tow may be wrapped around a mold to get the desired shape of the component;

FIG. 3A is a cross-section view of the tow of FIG. 3 taken along line A-A showing a first filament composition of the tow at a first section of the tow;

FIG. 3B is a cross-section view of the tow of FIG. 3 taken along line B-B showing a second filament composition of the tow at a second section of the tow;

FIG. 4 is a diagrammatic view of a method of forming the component of FIG. 1 using ceramic tows having a varying filament composition;

FIG. 5 is a cross-section view of another ceramic matrix composite component for use in a gas turbine engine that is similar to the component of FIG. 1 showing the component is made from an inner tube and an outer shell;

FIG. 5A is an enlarged detail view of FIG. 5 showing the microstructure of the outer shell includes smaller filaments and a greater number of filaments per tow to increase the toughness of the ceramic matrix composite materials and the microstructure of the inner tube includes larger filaments and a fewer number of filaments per tow to increase the proportional limit of the ceramic matrix composite material;

FIG. 6 is a diagrammatic view of the method of using different sets of ceramic tows to form the inner tube and the outer shell of the component;

FIG. 7 is a graph of the stress-strain curve of the inner tube of the component; and

FIG. 8 is a graph of the stress-strain curve of the outer shell of the component showing the proportional limit is less than that of the inner tube.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

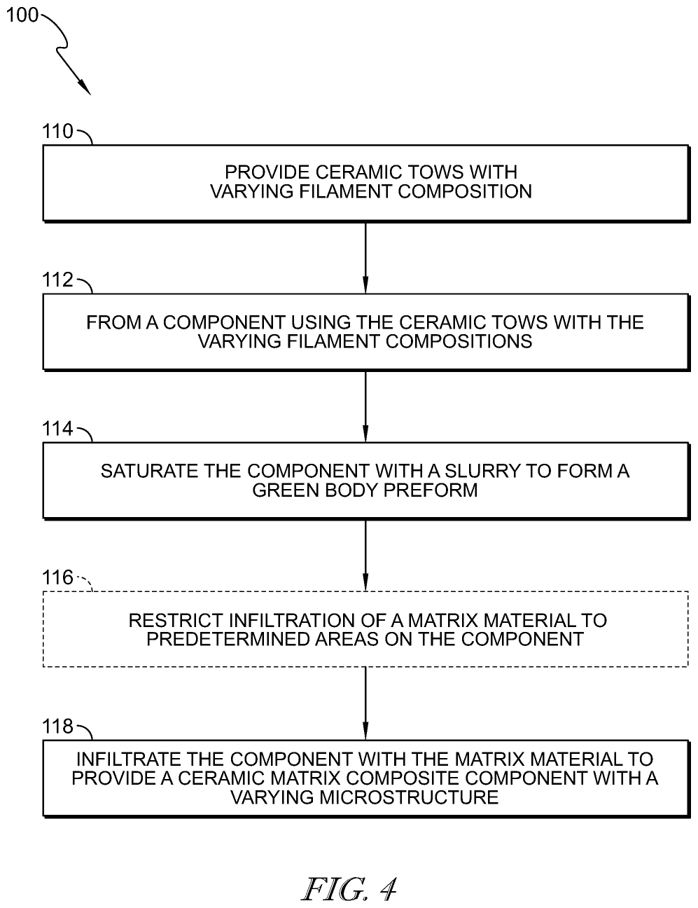

An illustrative ceramic matrix composite component 10 adapted for use in a gas turbine engine is shown in FIG. 1. The ceramic matrix composite component 10 has a tuned microstructure that meets conflicting structural requirements of the component during use in the gas turbine engine. A method 100 of manufacturing the tuned microstructure is shown in FIG. 4. The method 100 includes varying the intra-tow porosity of different sections of the component 10 thereby effecting the structural performance at different locations on the component 10.

Common ceramic matrix composite component manufacturing provides the same notional material properties throughout the component. Such manufacturing processes use the same filament size distribution and number of filaments per tow throughout the CMC. Consequently, the structural properties of the ceramic matrix composite material are the same at all locations of the component.

The present disclosure teaches tuning the structural properties of the component to better meet design requirements. The method 100 includes providing different sets of ceramic tows that may each have a different filament composition and/or varying the filament composition in the ceramic tows. The filament composition includes a filament size of the filaments included each tow, a filament size distribution in each tow, and a number of filaments per each tow.

By varying at least one of the filament size, the filament size distribution, and the number of filaments per each tow, the packing efficiency of the filaments is affected thereby influencing the infiltration characteristics. Once infiltrated the component has a varying intra-tow porosity (i.e. the porosity inside each tow) at different locations. The resulting variation in the intra-tow porosity at different locations of the component 10 allows the stress-strain response of the component 10 to be controlled to meet design needs.

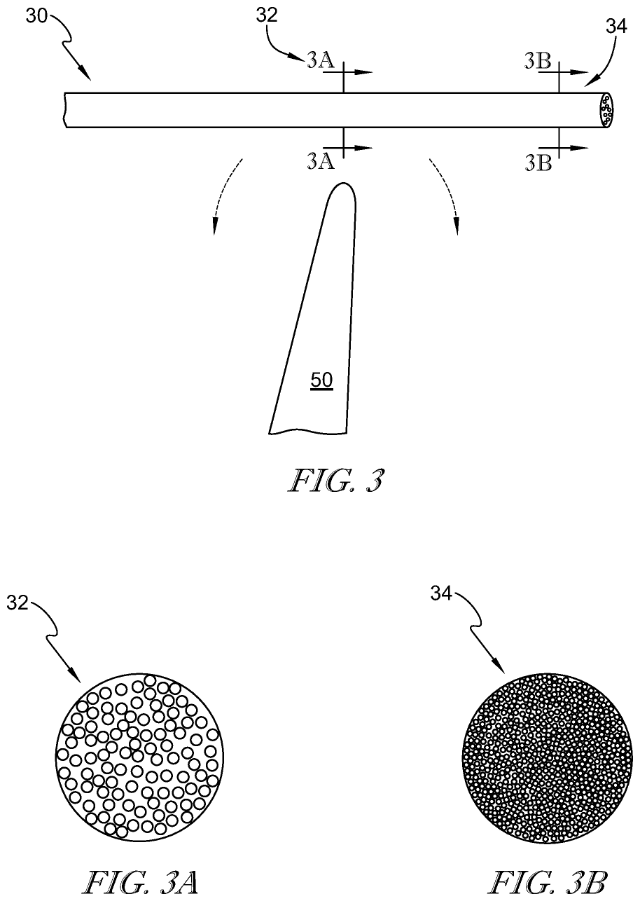

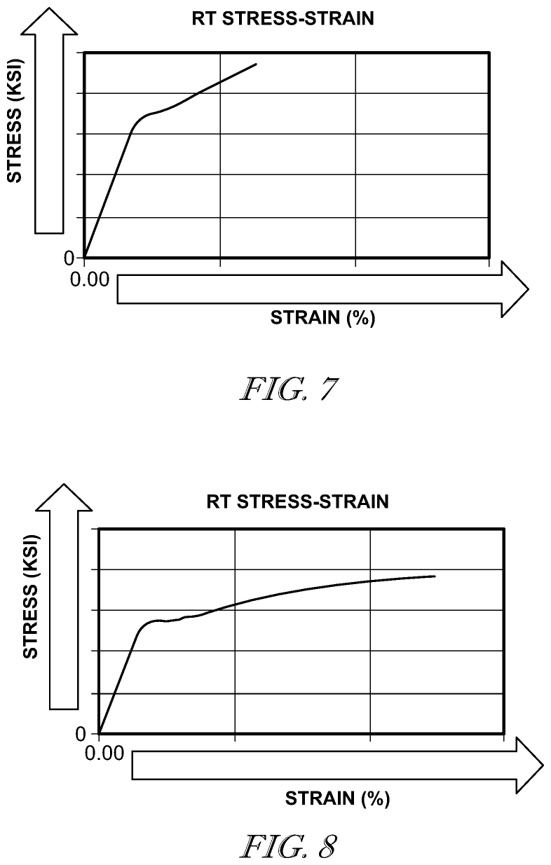

To increase the proportional limit and ultimate tensile stress in a section of the component 10, the tows in that section have a first filament composition. Such tows include (1) filaments with a larger filament size and (2) a fewer number of filaments per tow. The increased mean filament size and fewer number of filaments per tow leads to loose tow bundle packing as shown in FIG. 3A. As a result, the reduced intra-tow porosity provides the increased proportional limit and ultimate tensile stress as shown in FIG. 7

Conversely, to increase strain to failure and thus increase work of fracture in a different section of the component, the tows in that section have a second filament composition that is different from the first filament composition. Such tows include (1) filaments with a smaller filament size and (2) a greater number of filaments per tow. The reduced mean filament size and increased number of filaments per tow leads to tighter tow bundle packing as shown in FIG. 3B.

The minimal space between the filaments leads to poorer infiltration into the tow bundles, which leads to greater intra-tow porosity. The greater intra-tow porosity reduces the proportional limit and ultimate tensile stress due to poorer load transfer to the fibers. However, greater intra-tow porosity increases strain to failure and thus increased work of fracture in that section of the component 10 as shown in FIG. 7.

In the illustrative embodiment, the ceramic matrix composite component 10 is a turbine vane 10 as shown in FIG. 1. In some embodiments, the component 10 may be any ceramic matrix composite component adapted for use in a turbine or a combustor. In other embodiments, the component 10 may be any other ceramic matrix composite component adapted for use in the gas turbine engine where conflicting requirements of increased toughness or strain to failure and/or increased proportional limit (but decreased toughness) are present.

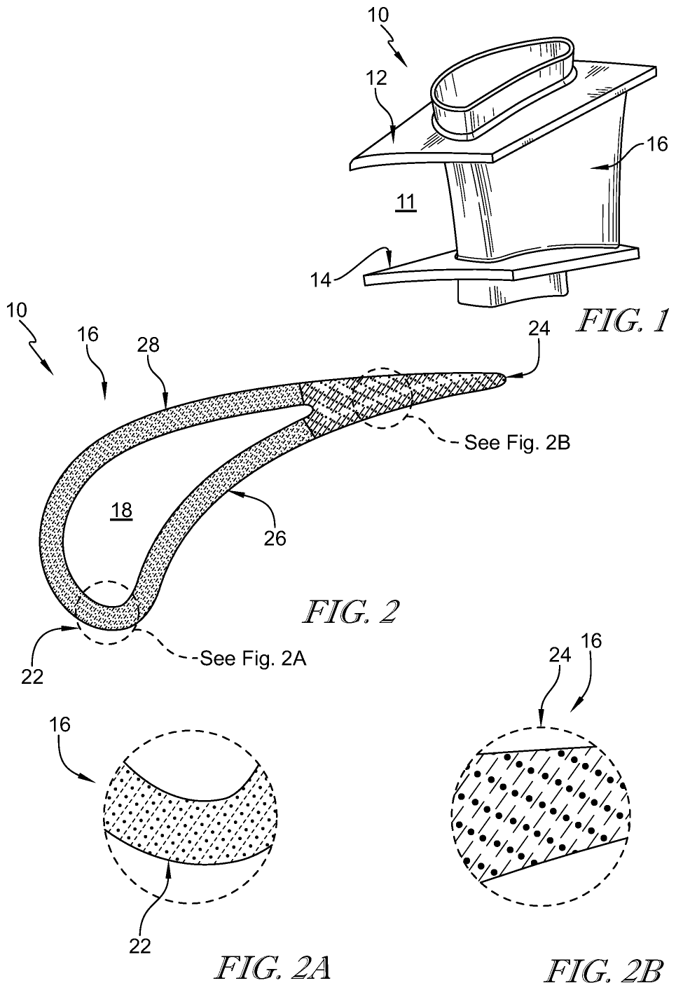

In the illustrative embodiment, the turbine vane 10 includes an outer platform 12, an inner platform 14, and an airfoil 16 as shown in FIGS. 1 and 2. The outer and inner platforms 12, 14 are spaced apart radially from one another relative to a central reference axis of the gas turbine engine to define the primary gas path 11 therebetween. The airfoil 16 extends from the outer platform 12 to the inner platform 14 across the primary gas path 11 and is shaped to include an interior passageway 18 that extends radially there through.

The airfoil 16 is shaped to redirect air flowing through the gas turbine engine by having a leading edge 22, a trailing edge 24, a pressure side 26, and a suction side 28 as shown in FIG. 2. The trailing edge 24 is axially spaced apart from the leading edge 22. The suction side 28 is circumferentially spaced apart from the pressure side 26. The pressure side 26 and the suction side 28 extend between and interconnect the leading edge 22 and the trailing edge 24.

The leading edge 22 as well as the pressure and suction sides 26, 28 may be subject to domestic or foreign object damage, which demands increased work of fracture, i.e. toughness. The trailing edge 24 may have different design requirements, such as a specific shape. The shape of the trailing edge 24 may be important for the aerodynamic function of the vane 10.

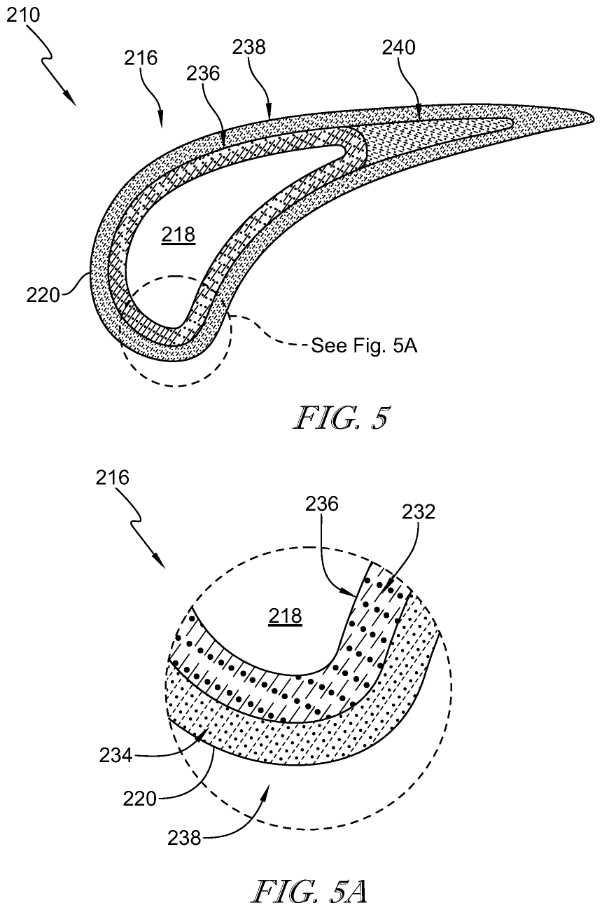

To achieve the different structural properties in the component 10, the method 100 includes varying the filament composition in the ceramic tows as suggested by box 110 in FIG. 5. An illustrative embodiment of a tow 30 with a varying filament composition is shown in FIG. 3.

In one section 32 of the tow 30, the tow 30 has the first filament composition in which the mean filament size is greater and number of filaments per tow is reduced as shown in FIG. 3A. The increased mean filament size and fewer number of filaments per tow leads to loose tow bundle packing. The resulting intra-tow porosity provides an increased proportional limit and ultimate tensile stress as shown in FIG. 7. The properties of the tows 30 may make it easier to shape the trailing edge 24 of the airfoil 16.

In a different section 34 of the tow 30, the tow 30 has the second filament composition in which the mean filament size is lower and number of filaments per tow is increased as shown in FIG. 3B. The reduced mean filament size and increased number of filaments per tow leads to tighter tow bundle. The resulting intra-tow porosity increases strain to failure and thus increased work of fracture as shown in FIG. 8.

The preform of the component 10 is formed using the tows 30 as suggested by box 112. In some embodiments, the tows 30 may be woven to form two-dimensional layers that will be formed around a mold 50. In the illustrative embodiment, the tows 30 are formed around a mold 50 so that the section 32 of the tow 30 with the first filament composition is located at the trailing edge 24 of the airfoil 16. At the same time, the section 34 of the tow 30 with the second filament composition forms the leading edge 22, the pressure side 26, and the suction side 28 of the airfoil 16 as suggested in FIG. 3.

Once the shape of the component 10 is formed, the component 10 is saturated or filled with a slurry to form the green body preform (not shown) as suggested by box 114 in FIG. 5. The slurry is allowed to dry before the component 10 is infiltrated with a matrix material as suggested by box 118 in FIG. 5. In the illustrative embodiment, the infiltration step 118 is a chemical vapor infiltration process.

Once infiltrated, the ceramic matrix composite component 10 is fully formed as shown in FIG. 1 is formed. The component 10 has a varying microstructure at different sections 22, 24, 26, 28 of the airfoil 16 as shown in FIGS. 2A and 2B. For example, the leading edge 22 and the pressure and suction sides 26, 28 have a greater intra-tow porosity than the section that forms the trailing edge 24.

In some embodiments, the method 100 may further include restricting infiltration of the matrix material to predetermined surfaces of the component as suggested by box 116 in FIG. 5. By restricting what surfaces the matrix material infiltrates, the infiltration of the matrix material is forced to flow to other surfaces of the component 10. As a result, the infiltration creates a deposition gradient in the component 10.

The infiltration of the matrix material may be restricted a variety of ways. In some embodiments, different hole patterns may be used to restrict the flow of matrix material to certain areas of the component 10. In other embodiments, solid graphite tooling may be used on one side of the component 10. The tooling blocks or covers the surface sections of the component 10 where infiltration is meant to be restricted.

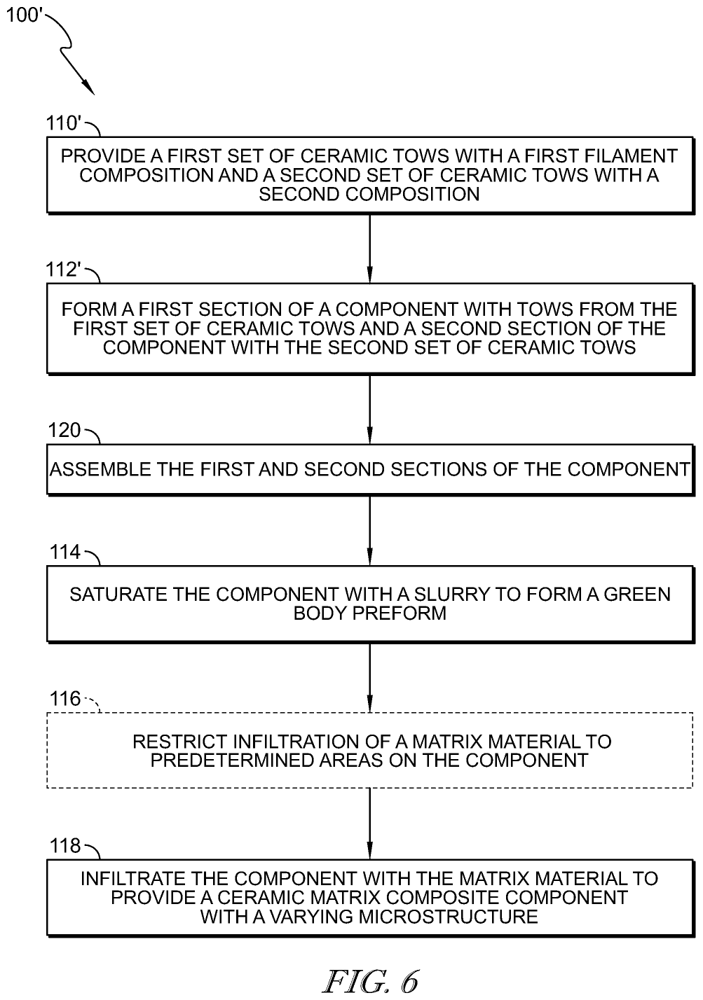

Another embodiment of a method 100′ of forming a ceramic matrix composite component 210 in accordance with the present disclosure is shown in FIG. 6. The resulting component 210 is substantially similar to the component 10 shown in FIGS. 1-3B and described herein. Accordingly, similar reference numbers in the 220 series indicate features that are common between the component 10 and the component 210. The description of the component 10 is incorporated by reference to apply to the component 210, except in instances when it conflicts with the specific description and the drawings of the component 210.

The component 210 is substantially similar to the component 10 except to form the component 210, the method 100′ comprises providing different sets of ceramic tows with varying filament compositions to form different sections 232, 234 of the component 210. The first set of ceramic tows includes tows with the first filament composition, while the second set of ceramic tows includes tows with the second filament composition as suggested by box 110′ in FIG. 6. The different sets of ceramic tows are formed into two-dimensional layers to form different parts of the component 210 in the illustrative embodiment.

Like the component 10 in FIGS. 1-3B, the component 210 is a turbine vane in the illustrative embodiment. The turbine vane 210 includes an airfoil 216 as shown in FIG. 5. In the illustrative embodiment, the airfoil 216 is further shaped to include an interior passageway 218 that extends radially through the airfoil 216. The passageway 218 is sized to receive a portion of a support structure included in the gas turbine engine. The support structure is made with metallic materials to provide structural support for the turbine vane 210.

In some embodiments, the interior passageway 218 may be supplied cooling air to cool the metallic materials in the passageway 218. Therefore, the interior passageway 218 may need to have an increased proportional limit to resist the pressure load (hoop stress) due to internal coolant overpressure. Simultaneously, an outer surface 220 of the airfoil 216 may be subject to domestic or foreign object damage. Therefore, the outer surface 220 may need increased work of fracture (toughness). In the illustrative embodiment, the component 210 includes different sections 236, 238 that utilize different ceramic tows.

In the illustrative embodiment, the component 210 includes an inner tube 236 and an outer shell 238 as shown in FIGS. 5 and 5A. The inner tube 236 forms the interior passageway 218, while the outer shell 238 forms the outer surface 220.

The first set of ceramic tows 232 may be used to form the inner tube 236, while the second set of ceramic tows 234 may be used to form the outer shell 238 as suggested by box 112′. The outer shell 238 may be formed with the first set of tows with a smaller filament size and greater filaments/tow, while the inner tube 236 may be formed from larger filaments with fewer filaments/tow, thereby influencing the infiltration processing and hence intra-tow porosity which controls stress-strain response.

The step of forming the different sections 236, 238 may be done in different ways. In the some embodiments, the first set of ceramic tows 232 may be used to form two-dimensional layers that are layered to form the inner tube 236. The tows 232 may be woven together to form the two-dimensional plies. In other embodiments, the first set of ceramic tows 232 may be woven together to form a three-dimensional structure that forms the inner tube 236.

Similarly, in some embodiments, the second set of ceramic tows 234 may be used to form two-dimensional layers that are layered to form the outer shell 238. The tows 234 may be woven together to form the two-dimensional plies. In other embodiments, the second set of ceramic tows 234 may be woven together to form a three-dimensional structure that forms the outer shell 238.

In the illustrative embodiment, the component 210 includes a trailing edge wedge 240 as shown in FIG. 5. The trailing edge wedge 240 may have a third filament composition that is different from the first and second filament compositions in some embodiments.

The inner tube 236 may then be inserted into the outer shell 238 before the component 210 is infiltrated with the matrix material as suggested by box 120. This way, the inner tube 236 and the outer shell 238 form an integral, one-piece ceramic matrix composite component 210 once the component 210 is infiltrated.

In the illustrative embodiment, the assembled sections 236, 238 of the component 210 may be saturated with a slurry and allowed to dry as suggested by box 114. In some embodiments, the sections 236, 238 may be saturated separately and then assembled. Once the green body preform is formed, the method 100′ includes infiltrating the component 210 with the matrix material as suggested by box 118.

In some embodiments, the method 100′ may further include restricting infiltration of the matrix material to predetermined surfaces of the component as suggested by box 116 in FIG. 5. By restricting what surfaces the matrix material infiltrates, the infiltration of the matrix material is forced to flow to other surfaces of the component 10. As a result, the infiltration creates a deposition gradient.

In some embodiments, steps from method 100 may be combined with method 100′. In some embodiments, certain sections 236, 238 of the component 210 may be formed with tows 30 that have a varying filament composition. For example, the outer shell 238 may be formed using the method 100 so that the leading edge 22 as well as the pressure and suction sides 26, 28 have an increased work of fracture, while the trailing edge 24 has an increased ultimate tensile strength.

In other embodiments, the different sets of ceramic tows 232, 234 may be woven together to form two-dimensional plies with a varying filament composition. The varying filament composition of the two-dimensional layer may then be used to form the section of the component 10, 210. The two-dimensional layer with the varying filament composition may have a section 32 with the first filament composition, while another section 34 has the second filament composition. When the layer is wrapped around the mold 50, the sections 32, 34 form parts of the leading edge 22, the trailing edge 24, the pressure side 26, and/or the suction side 28.

The present disclosure relates to tuning the microstructure of a ceramic matrix composite component 10, 210 in specific areas. This enables the component 10, 210 to have different structural properties throughout the component 10, 210 to meet different design needs. Specifically, the local stress-strain response may be changed by optimising the microstructure in key geometric locations to meet the functional requirements of the design.

In some embodiments, the component 10, 210 may be a turbine vane. The vane 10, 210 may have an internal vane cavity that may need an increased proportional limit to resist the pressure load (hoop stress) due to internal coolant. Simultaneously, the external shell of the vane may be subject to domestic or foreign object damage, which may therefore need an increased work of fracture (toughness).

These two design characteristics may be achieved locally in the same part by varying the mean filament size within the tow bundle and/or the number of filaments per tow. The filament composition thereby influences the infiltration characteristics, and subsequently affects slurry and melt infiltration.

In another embodiment, a similar effect may be achieved by constricting infiltration, such as the chemical vapour infiltration, to one surface to create a deposition gradient. The flow of vapour infiltration may be constricted by using solid graphite tooling on one side. In other embodiments, both filament size, tow bundle filaments, infiltration could all be tuned.

In the illustrative embodiment, the external shell of the vane may utilise tows with smaller filament size and greater filaments/tow. Reduced mean filament size may lead to tighter tow bundle packing, which creates poorer infiltration into the tow bundles. As a result, that section of the component may have a greater intra-tow porosity, which may lead to a reduced proportional limit/ultimate tensile strength due to poorer load transfer to fibers. This increases strain to failure and consequently an increased work of fracture.

Additionally, the inner tube may be constructed from larger filaments with fewer filaments/tow. This may provide higher proportional limit/ultimate tensile strength and reduced work of fracture.

The method of varying the microstructure of the component may help with any ceramic matrix composite structure that has a conflicting requirement of increased toughness or strain to failure and increased proportional limit (but decreased toughness). The controlling of the intra-tow porosity in different positions within the component may allow the component to be tuned for the different design requirements. Current component manufacturing provides the same notional material properties throughout the structure by utilizing the same filament size distribution and number of filaments per tow, throughout the component.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A method of forming a ceramic matrix composite component,
the method comprising providing a first set of ceramic tows that each have a first filament composition,
providing a second set of ceramic tows that each have a second filament composition that is different from the first filament composition by varying at least one of a mean filament size of filaments included each tow, a filament size distribution of each tow, and a number of filaments per each tow,
forming a first section of the component using tows from the first set of ceramic tows,
forming a second section of the component that is different from the first section using tows from the second set of ceramic tows,
infiltrating the component with matrix material to produce a first intra-tow porosity in the first section of the component and a second intra-tow porosity in the second section of the component that is different from the first intra-tow porosity of the first section.

2. The method of claim 1, further comprising restricting the matrix material from infiltrating the component at a predetermined surface area of the component.

3. The method of claim 2, wherein the second filament composition is different from the first filament composition by varying the mean filament size of the filaments included each tow, the filament size distribution of each tow, and the number of filaments per each tow.

4. The method of claim 3, wherein the second filament composition has a mean filament size that is less than a mean filament size of the first filament composition.

5. The method of claim 3, wherein the second filament composition has a mean filament size that is greater than a mean filament size of the first filament composition.

6. The method of claim 1, wherein the ceramic matrix composite component is a turbine vane adapted for use in a gas turbine engine.

7. The method of claim 6, wherein the turbine vane includes an outer platform that extends circumferentially at least partway about a central axis of the gas turbine engine, an inner platform that extends circumferentially at least partway about the central axis of the gas turbine engine and spaced apart radially from the outer platform, and an airfoil that extends radially between the outer and inner platforms, and wherein forming the first section of the component includes forming an inner tube of the airfoil, forming the second section of the component includes forming an outer shell of the airfoil, and the method further includes assembling the inner tube into the outer shell of the airfoil before infiltrating the component.

8. The method of claim 7, wherein the airfoil is shaped to redirect air flowing through the gas turbine engine by having a leading edge, a trailing edge spaced apart axially from the leading edge, a pressure side, and a suction side spaced apart circumferentially from the pressure side, the pressure side and the suction side extend between and interconnect the leading edge and the trailing edge, and the method further comprises restricting the matrix material from infiltrating the component at a predetermined surface area on at least one of the leading edge, the trailing edge, the pressure side, and the suction side of the component.
